(19) United States
(12) Patent Application Publication
(10) Pub. No.: US 2007/0215584 A1
(43) Pub. Date: Sep. 20, 2007

(54) Method and apparatus for bonding electronic elements to substrate using laser beam

(76) Inventors: Gi-Jung Nam, Seoul (KR); No-Heung Kwak, Seoul (KR)

Correspondence Address: JORDAN AND HAMBURG LLP, 122 EAST 42ND STREET, SUITE 4000, NEW YORK, NY, 10168, US

(21) Appl. No.: 11/725,268

(22) Filed: Mar. 19, 2007

(30) Foreign Application Priority Data
Mar. 20, 2006 (KR) 10-2006-25205

(51) Int. Cl. B23K 26/20

(52) U.S. Cl. 219/121.85

(57) ABSTRACT

In a method and apparatus for bonding an electronic element to a substrate, a laser beam is generated, pressure is applied to the substrate, a connecting medium, and an electronic element, which are stacked, and the electronic element is bonded to the substrate through heat fusion of the connecting medium by fusing the connecting medium by irradiating the laser beam to the substrate and the electronic element while applying pressure to the substrate, the connecting medium, and the electronic element. The laser beam of a line type or an area type has uniform quality through use of a homogenizer. The laser beam is output in a continuity mode at an initial stage, and is output in a pulse mode at a fusing stage.

### BACKGROUND OF THE INVENTION

1. Field of the Invention

The present invention relates to a technique for bonding electronic elements, such as an electronic chip and a film, to the surface of a glass substrate of a flat panel display or a film, and more particularly to a method and apparatus for bonding electronic elements to a substrate using a laser beam, which is applied to various fields, such as chip on glass (COG), film on glass (FOG), chip on film (COF), chip on board (COB), and anisotropic conductive film (ACF) fields.

2. Description of the Related Art

A technique for bonding an electronic element to a substrate using an anisotropic conductive film, which is generally used to mount a flat panel display device, has been known. That is, the anisotropic conductive film in a double-sided tape state, which is obtained by mixing an adhesive hardened by heat and fine conductive balls, is interposed between the electronic element and the substrate, and heat and pressure are applied to the anisotropic conductive film so as to bond the electronic element to the substrate.

In case that two media are bonded using the anisotropic conductive film, as described above, since the anisotropic conductive film must maintain constant temperature and pressure for a constant time in view of characteristics of the thermosetting resin. Thus, an apparatus, provided with a hot bar 1 having a heater, applies pressure to a pressure surface of an electronic element 3 through the hot bar 1, thus achieving heat fusion, as shown in FIG. 1. That is, after an anisotropic film 4 is located between a glass substrate 2 and the electronic element 3, the hot bar 1 applies heat and pressure to the surface of the electronic element 3 in the direction of the arrow, thus bonding the electronic element 3 and the glass substrate 2 to each other.

As shown in FIG. 2, the above bonding method includes preparing the glass substrate 2 (S1), pre-bonding the anisotropic conductive film 4 to the glass substrate 2 (S2), peeling a protection film 4a from the anisotropic conductive film 4 (S3), locating the electronic element 3, to be bonded, to a regular position on the glass substrate 2 (S4), main-bonding the electronic element 3 to the glass substrate 2 through heat fusion by applying pressure to the surface of the electronic element 3 using the hot bar 1 (S5), and separating the hot bar 1 from the surface of the electronic element 3 (S6).

When the anisotropic conductive film 4 is located between the glass substrate 2 and the electronic element 3, to be bonded, and the hot bar 1 applies heat and pressure of a designated degree to the surface of the electronic element 3 located on the anisotropic conductive film 4, the thermosetting resin of the anisotropic conductive film 4 is hardened, as time passes, and two bonding surfaces are bonded to each other. Then, electricity flows only in one direction due to conductive particles, which disperse in the anisotropic conductive film 4.

Since the heat from the hot bar 1 is transferred to the anisotropic conductive film 4 through the electronic element 3, it is important to have a regular heat transfer property.

In the conventional bonding method, the heat fusion of the anisotropic conductive film 4 is achieved by applying heat and pressure to the anisotropic conductive film 4 using the hot bar 1, and heat required to the heat fusion of the anisotropic conductive film 4 is generated by heating and controlling the hot bar 1 using the heater installed therein. Accordingly, the overall temperature of the hot bar 1 cannot have a uniform distribution in view of characteristics of the hot bar 1 and the electric heater installed therein, and it takes a long time to transfer heat to the bonding portion of the electronic element 3 to the glass substrate 2, thus decreasing the productivity. Further, heat is consumed by other portions rather than the bonding portion, thus deteriorating the heat efficiency. When the hot bar 1 is continuously used, the surface of the hot bar 1 is easily contaminated, and thus it is difficult to secure the repeatability.

Further, it is difficult to optimize the bonding conditions according to purposes of a target object to be bonded, and the bonding quality varies according to worker's experience and skill in case that the bonding is manually or semi-automatically carried out.

### SUMMARY OF THE INVENTION

Therefore, the present invention has been made in view of the above problems, and it is an object of the present invention to provide a method and apparatus for bonding electronic elements to a substrate using a laser beam, in which, when an electronic element is bonded to the substrate by heat fusion of a connecting medium interposed therebetween, such as an anisotropic conductive film or a polyimide film, the laser beam is used as a heat source, instead of a conventional hot bar, and heats only the bonding portion of the electronic element to the substrate, thereby shortening a temperature raising time required by the bonding, elaborately controlling the output of the laser beam to improve the reliability and repeatability of a bonding process, shortening an overall process time, and thus increasing the efficiency of the bonding process.

It is a further object of the present invention to provide a method and apparatus for bonding electronic elements to a substrate using a laser beam, in which the laser beam is converted from a spot scan-type beam to a line-type beam or an area-type beam, is improved in quality by employing a homogenizer, if necessary, and is elaborately controlled.

It is another object of the present invention to provide a method and apparatus for bonding electronic elements to a substrate using a laser beam, in which, when a connecting medium interposed between an electronic element and the substrate is fused and then reaches a hardening temperature by irradiating the laser beam thereon, the output of the laser beam is converted from a continuity mode to a pulse mode so as to continuously maintain the hardening temperature, thus suppressing the increase of the temperature of the connecting medium and maximizing the efficiency of a bonding process.

It is another object of the present invention to provide a method and apparatus for bonding electronic elements to a substrate using a laser beam, in which a beam transfer unit employs a mask with an adjustable size, thus adjusting the size of the laser beam correspondingly to the size of the bonding portion of an electronic element to the substrate.

It is yet another object of the present invention to provide a method and apparatus for bonding electronic elements to a substrate using a laser beam, in which a plurality of laser module assemblies, each of which generates the laser beam, are installed, and are simultaneously or selectively operated according to the number of bonding portions of the electronic elements bonded to the substrate so that each of the laser module assemblies irradiates the laser beam on the corresponding one of the bonding portions, thus simultaneously bonding a plurality of electronic elements to the substrate.

In accordance with one aspect of the present invention, the above and other objects can be accomplished by the provision of a method for bonding electronic elements to a substrate using a laser beam by a connecting medium interposed therebetween, comprising generating a laser beam with a designated wavelength; applying pressure to the substrate and the electronic element; and bonding the electronic element to the substrate in a conductive state through heat fusion of the connecting medium by fusing the connecting medium by irradiating the laser beam to the substrate and the electronic element while applying pressure to the substrate, the connecting medium, and the electronic element, wherein the irradiating direction of the laser beam is selectively decided according to the beam transmittance and absorbance of the material of the substrate or the electronic element in the bonding of the electronic element to the substrate.

The laser beam may be a line-type beam or an area-type beam.

The output of the laser beam may be converted from a continuity mode to a pulse mode after the laser beam reaches a designated hardening temperature of the connecting medium, so that the laser beam can constantly maintain the hardening temperature of the connecting medium, to suppress the increase of the temperature of the connecting medium.

In case that a plurality of laser modules are simultaneously installed and a plurality of electronic elements are bonded to the substrate, the plurality of laser modules may respectively irradiate laser beams onto corresponding bonding portions of the plurality of electronic elements to the substrate so as to simultaneously bond the plurality of electronic elements to the substrate.

A mask having an adjustable size may be installed at the middle of a traveling route of the laser beam toward the connecting medium, and adjust the size of the laser beam reaching the bonding portion of the electronic element to the substrate corresponding to the size of the bonding portion of the electronic element.

In accordance with another aspect of the present invention, there is provided an apparatus for bonding electronic elements to a substrate, comprising a laser driver providing electric output to a diode laser module and controlling the operation of the diode laser module; the diode laser module emitting a laser beam of a designated wavelength; a lens optical system employing a homogenizer and causing the laser beam to have a constant size; the laser beam irradiated through the lens optical system to have a designated width; a beam transfer unit employing a mask with an adjustable size and guiding the laser beam to a bonding portion of an electric element to the substrate; upper and lower pressure jig units applying pressure to the substrate, a connecting medium, and the electronic element, which are stacked, while the laser beam incident through the beam transfer unit is upwardly transmitted to the substrate; and a control unit setting up the intensity of the laser beam, the beam irradiating method and the applied pressure, and providing signals for controlling the laser beam and the upper and lower pressure jig units.

The upper pressure jig unit may be made of a transparent member, and the upper and lower pressure jig units may apply pressure to the substrate, the connecting medium, and the electronic element, which are stacked, while the laser beam incident through the beam transfer unit is downwardly transmitted to the electronic element.

A cooling unit may be provided in the upper and lower pressure jig units.

A plurality of assemblies, each of which includes the laser driver, the diode laser module, the lens optical system, the beam transfer unit, the upper and lower pressure jig units, and the control unit, may be installed so as to simultaneously bond a plurality of electronic elements to the substrate.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view for illustrating a conventional bonding technique;

FIGS. 2A to 2F are sectional views for respectively illustrating steps of a conventional bonding method;

FIG. 3 is a schematic view for illustrating a bonding technique in accordance with the present invention;

FIG. 4 is a graph for illustrating a temperature distribution at a bonding portion according to a variation of time when the bonding technique of the present invention is applied;

FIG. 5 a graph for illustrating a variation of output of a laser beam in FIG. 4;

FIG. 6 is a schematic perspective view of one preferred embodiment of a bonding apparatus in accordance with the present invention;

FIG. 7 is a schematic perspective view of another preferred embodiment of the bonding apparatus in accordance with the present invention;

FIG. 8 is a schematic view for illustrating another embodiment of the bonding technique in accordance with the present invention;

FIG. 9 is a schematic view for illustrating a modification of the embodiment of FIG. 8; and

FIG. 10 is a plan view of a mask, which is employed by the bonding apparatus of the present invention.

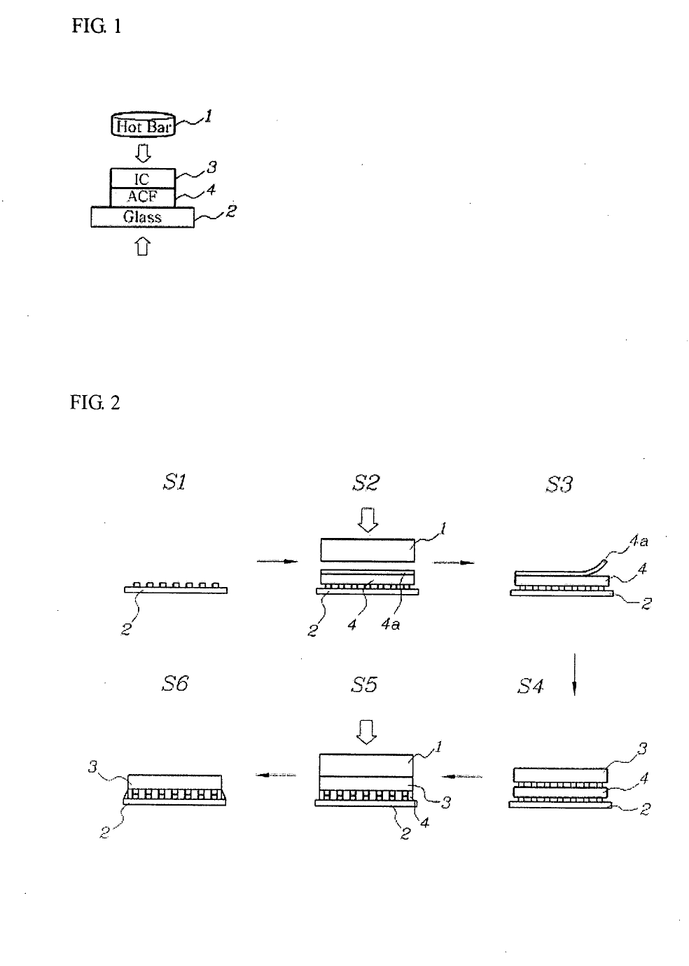

### DESCRIPTION OF THE PREFERRED EMBODIMENTS

Now, preferred embodiments of the present invention will be described in detail with reference to the annexed drawings.

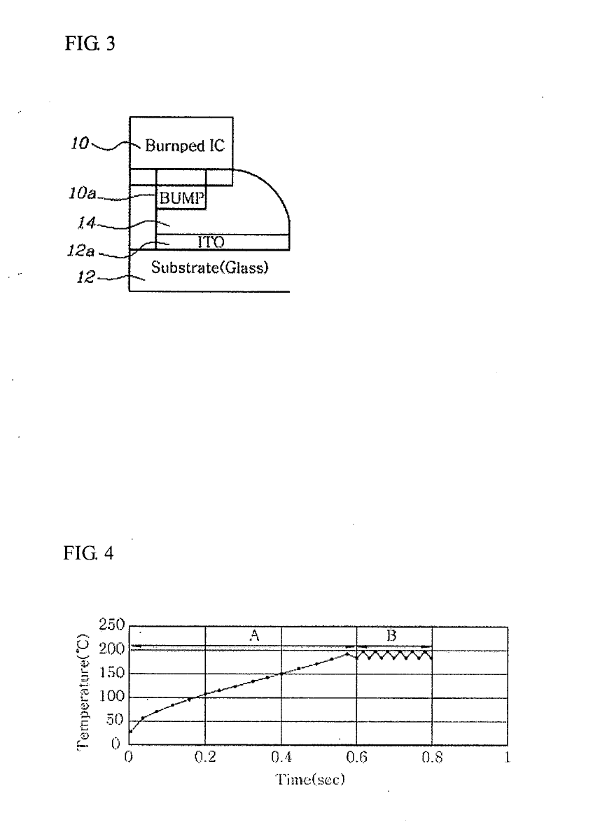

The present invention relates to a technique for connecting and bonding an electronic element 10 to a substrate 12, as shown in FIG. 3. That is, electrodes 12a of the substrate 12 and bump electrodes 10a of the electronic element 10, which lies above the substrate 12, are bonded by a connecting medium 14. A laser beam 50 is transmitted by the substrate 12, which is made of transparent glass, and a portion of the laser beam 50 is absorbed by a coating film on the electrodes 12a and most of the laser beam 50 is absorbed by the connecting medium 14 located between the substrate 12 and the electronic element 10. The energy of the laser beam 50, which is absorbed by the connecting medium 14, is converted into heat, and the heat fuses and hardens the connecting medium 14 so that the electrodes 12a of the substrate 12 and the bump electrodes 10a of the electronic element 10 are connected to each other by the connecting medium 14. The above connecting and bonding technique utilizes a principle of that the connecting and bonding of the substrate 10 and the electronic element 10 is achieved by heat generated due to the absorption of the laser beam 50 by the connecting medium 14, in consideration of the absorption of the laser beam 50 by the electrodes 12s of the substrate 12, the absorption of the laser beam 50 by the connecting medium 14, and the transmission of the laser beam 50 by the substrate 12.

First, an apparatus for bonding the electronic element 10 to the substrate 12 will be described. The bonding apparatus includes a laser driver 20 providing electric output to a diode laser module 30 and controlling the operation of the diode laser module 30, the diode laser module 30 emitting a laser beam 50 of a designated wavelength, a lens optical system 40 causing the laser beam 50 to have high quality and a constant size by employing a homogenizer, the laser beam 50 irradiated through the lens optical system 40 to have a designated width, a beam transfer unit 60 employing a mask 62 with an adjustable size and guiding the laser beam 50 to a bonding portion, upper and lower pressure jig units 70 and 80 applying pressure to the substrate 12, the connecting medium 14 and the electronic element 10, which are stacked, while the laser beam 50 incident through the beam transfer unit 60 is upwardly transmitted to the substrate 12, and a control unit 90 setting up the intensity of the laser beam 50, the beam irradiating method and the applied pressure, and providing signals for controlling the laser beam 50 and the upper and lower pressure jig units 70 and 80.

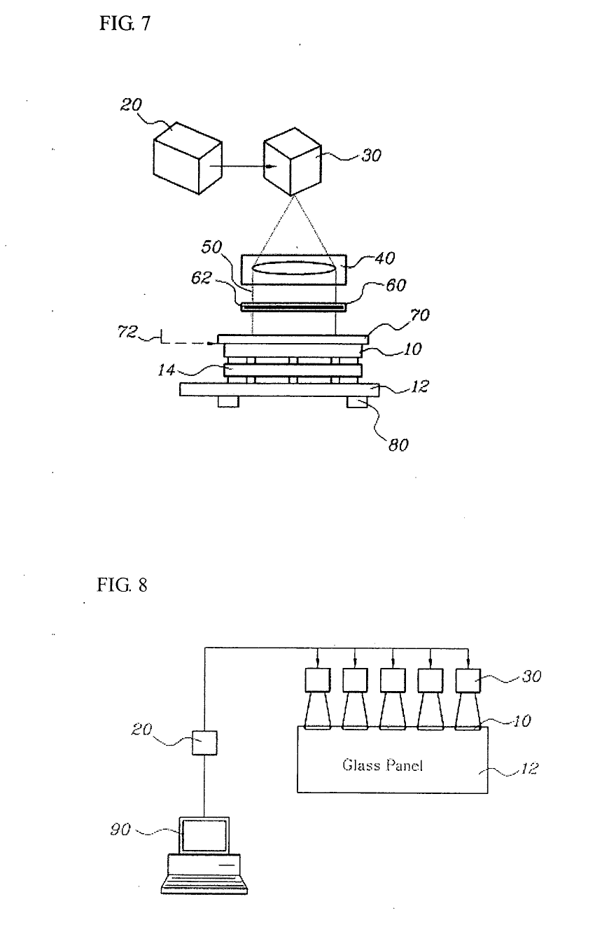

As shown in FIG. 7, the upper pressure jig unit 70 may be made of a transparent member, and the upper and lower pressure jig units 80 may apply pressure to the substrate 12, the connecting medium 14 and the electronic element 10, which are stacked, while the laser beam 50 incident through the beam transfer unit 60 is downwardly transmitted to the electronic element 10.

In order to prevent the upper and lower pressure jig units 70 and 80 from being overheated due to the transfer and accumulation of the heat generated from the laser beam 50 when the upper and lower pressure jig units 70 and 80 are repeatedly operated, a separate cooling unit may be provided. For example, an air-cooled type cooling line 72 is installed.

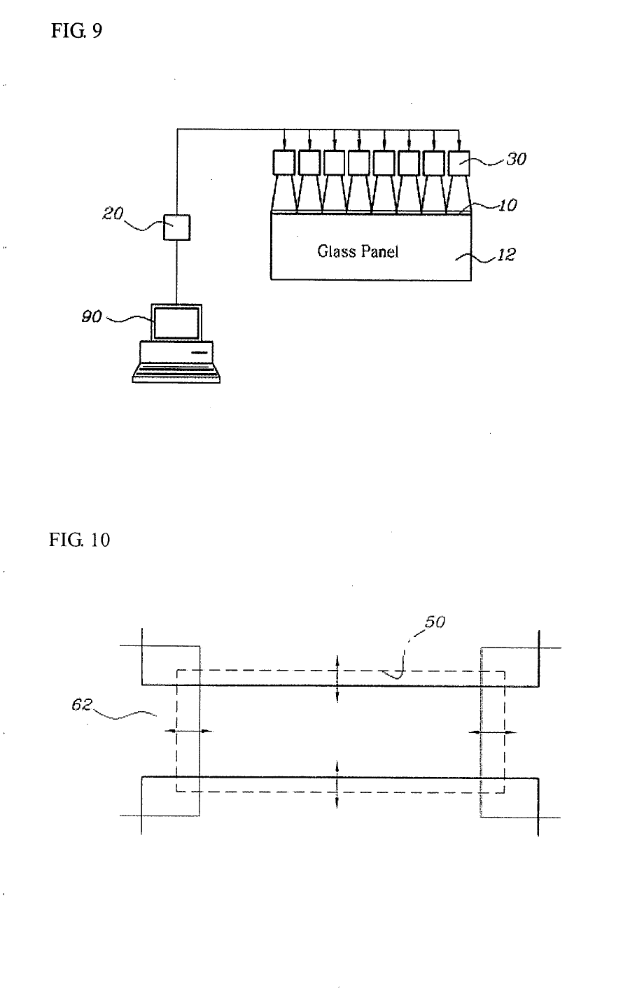

Further, as shown in FIGS. 8 and 9, a plurality of assemblies, each of which includes the laser driver 20, the laser module 30, the lens optical system 40, the beam transfer unit 60, the upper and lower pressure jig units 70 and 80, and the control unit 90, may be installed and be simultaneously or selectively operated to bond a plurality of bonding portions between electronic elements and a substrate.

As shown in FIG. 8, the assemblies may be configured such that laser beams of the assemblies are separately irradiated, thus being simultaneously or selectively operated. As shown in FIG. 9, the assemblies may be configured such that laser beams of the assemblies are successively irradiated, thus being simultaneously operated throughout a broad region.

The mask 62 of the beam transfer unit 60, as shown in FIG. 10, has a size, which is smaller than the size of the laser beam 50 and is adjusted by sliding in the longitudinal or transversal direction as indicated by the arrow. Preferably, the size of the mask 62 is adjusted in advance according to the size of the bonding portion between the substrate 12 and the electronic element 10.

Hereinafter, a bonding method of the present invention using the above-described bonding apparatus will be described.

The bonding method of the present invention includes generating the laser beam 50 of a designated wavelength (first step), applying pressure to the substrate 12 and the electronic element 10 (second step), and bonding the substrate 12 and the electronic element 10 in a conductive state through heat fusion of the connecting medium 14 by fusing the connecting medium 14 by irradiating the laser beam 50 to the substrate 12 and the electronic element 10 while applying pressure to the substrate 12, the connecting medium 14, and the electronic element 10 (third step). The third step includes selectively deciding the irradiating direction of the laser beam 50 according to the beam transmittance and absorbance of the material of the substrate 12 or the electronic element 10.

Hereinafter, the first to third steps of the bonding method of the present invention will be described in details.

First Step (Generating Laser Beam)

The laser module 30, the operation of which is controlled by the laser driver 20 under the control of the control unit 60, generates a laser beam 50 with a specific wavelength, and the lens optical system 40 causes the generated laser beam 50 to have excellent quality and a constant size. The size of laser beam 50 through the lens optical system 40 is adjusted by controlling the longitudinal and transversal widths of the mask 62 of the beam transfer unit 60 so as to correspond to the size of the bonding portion between the electronic element 10 and the substrate 12. Accordingly, the size of the laser beam 50 may be adjusted so as to correspond to various sizes of the bonding portion between the electronic element 10 and the substrate 12. Thereby, the laser beam 50 may be commonly used in various devices having different sizes.

Further, the laser beam 50 is a line-type beam or an area-type beam.

In the first step, as shown in FIG. 9, when a plurality of laser modules 30 are simultaneously installed and a plurality of electronic elements 10 are bonded to the substrate 12, the laser modules 30 respectively correspond to bonding portions of the electronic elements 10 to the substrate 12 and respectively irradiate laser beams 50 on the bonding portions, thus simultaneously bonding the electronic elements 10 to the substrate 12.

Second Step (Applying Pressure to Electronic Element and Substrate)

In the second step, the substrate 12, the connecting medium 14, and the electronic element 10 are vertically stacked at a regular position between the upper and lower pressure jig units 70 and 80, and the upper and lower pressure jig units 70 and 80 simultaneously apply pressure to the electronic element 10 and the substrate 12 downwardly and upwardly. That is, pressure is applied to the electronic element 10 and the substrate 12 in advance. Thereby, as soon as the laser beam 50 is irradiated on the substrate 12, the connecting medium 14 and the electronic element 10 in the third step, the electronic element 10 will be immediately bonded to the substrate 12.

Third Step (Bonding Electronic Element to Substrate)

In the third step, the laser beam 50 generated in the first step is irradiated on the substrate 12, the connecting medium 14 and the electronic element 10. The laser beam 50 is upwardly transmitted by the substrate 12 to reach the connecting medium 14, as shown in FIG. 6, or is downwardly transmitted by the electronic element 10 through the upper pressure jig unit 70, made of a transparent member, to reach the connecting medium 14, as shown in FIG. 7. The energy of the laser beam 50 absorbed by the connecting medium 14 is converted into heat, and the heat fuses and hardens the connecting medium 14, while the upper and lower pressure jig units 70 and 80 respectively apply pressure to the electronic element 10 and the substrate 12. Then, the electronic element 10 is bonded to the substrate 12 in a conductive state through heat fusion of the connecting medium 14.

That is, the electronic element 10 is connected and bonded to the substrate 12. The electronic element 10 is bonded to the substrate 12 located below the electronic element 10 by the connecting medium 14. The laser beam 50 is transmitted by the substrate 12 made of transparent glass or the electronic element 10, and is absorbed by the connecting medium 14. The energy of the laser beam 50 absorbed by the connecting medium 14 is converted into heat, and the heat fuses and hardens the connecting medium 14 so that the electronic element 10 and the substrate 12 are bonded to each other through heat fusion of the connecting medium 14.

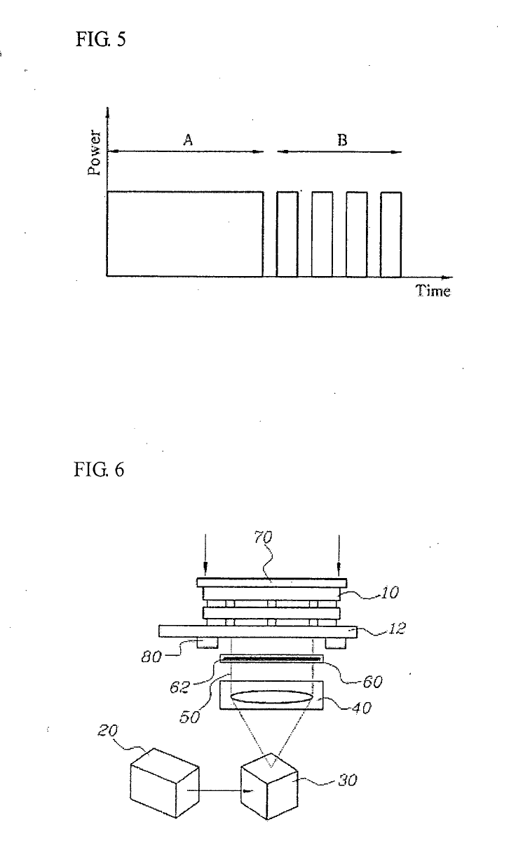

Preferably, the output of the laser beam 50 is controlled such that the laser beam 50 constantly maintains a designated hardening temperature of the connecting medium 14 after the laser beam 50 reaches the hardening temperature. As shown in FIGS. 4 and 5, the output of the laser beam 50 is continuously carried out (i.e., in a continuity mode) during the period ‘A’ to increase the temperature of the connecting medium 14, and when the connecting medium 14 reaches the hardening temperature, in order to constantly maintain the temperature of the connecting medium 14, the output of the laser beam 50 is converted from the continuity mode to a pulse mode to suppress the increase of the temperature of the connecting medium 14 and to maintain the constant temperature of the connecting medium 14 during the period ‘B’. Thereby, it is possible to improve the bonding effect.

As apparent from the above description, the present invention provides a method and apparatus for bonding electronic elements to a substrate using a laser beam, which has several advantages, as follows.

When an electronic element is bonded to the substrate by heat fusion of a connecting medium, interposed therebetween and made of an anisotropic conductive film or a polyimide film, the laser beam is used as a heat source, instead of a conventional hot bar, and heats only the bonding portion of the electronic element to the substrate. Accordingly, it is possible to shorten a temperature raising time required by the bonding and to precisely control the output of the laser beam, thereby improving the reliability and repeatability of a bonding process and shortening an overall process time and thus increasing the efficiency of the bonding process.

The laser beam is a line-type beam or an area-type beam, has improved quality through a homogenizer, if necessary, and is elaborately controlled. When the connecting medium interposed between the electronic element and the substrate is fused and then reaches a hardening temperature by irradiating the laser beam thereon, the output of the laser beam is converted from a continuity mode to a pulse mode so as to continuously maintain the constant hardening temperature, thus suppressing the increase of the temperature of the connecting medium and maximizing the efficiency of the bonding process.

A beam transfer unit employs a mask with an adjustable size, thus adjusting the size of the laser beam correspondingly to the size of the bonding portion of the electronic element to the substrate. Further, a plurality of laser module assemblies, each of which generates the laser beam, are installed, and are simultaneously or selectively operated according to the number of bonding portions of electronic elements to the substrate so that each of the corresponding laser module assemblies irradiates the laser beam, thus simultaneously bonding a plurality of electronic elements to the substrate.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for bonding electronic elements to a substrate using a laser beam by a connecting medium interposed therebetween, comprising:
generating a laser beam with a designated wavelength;
applying pressure to the substrate and the electronic element; and
bonding the electronic element to the substrate in a conductive state through heat fusion of the connecting medium by fusing the connecting medium by irradiating the laser beam to the substrate and the electronic element while applying pressure to the substrate, the connecting medium, and the electronic element,
wherein the irradiating direction of the laser beam is selectively decided according to the beam transmittance and absorbance of the material of the substrate or the electronic element in the bonding of the electronic element to the substrate.

2. The method according to claim 1, wherein the laser beam is a line-type beam or an area-type beam.

3. The method according to claim 1, wherein the output of the laser beam is converted from a continuity mode to a pulse mode after the laser beam reaches a designated hardening temperature of the connecting medium, so that the laser beam can constantly maintain the hardening temperature of the connecting medium, to suppress the increase of the temperature of the connecting medium.

4. The method according to claim 1, wherein, in case that a plurality of laser modules are simultaneously installed and a plurality of electronic elements are bonded to the substrate, the plurality of laser modules respectively irradiate laser beams onto corresponding bonding portions of the plurality of electronic elements to the substrate so as to simultaneously bond the plurality of electronic elements to the substrate.

5. The method according to claim 1, wherein a mask having an adjustable size is installed at the middle of a traveling route of the laser beam toward the connecting medium and adjusts the size of the laser beam reaching the bonding portion of the electronic element to the substrate corresponding to the size of the bonding portion of the electronic element.

6. An apparatus for bonding electronic elements to a substrate, comprising:
a laser driver providing electric output to a diode laser module and controlling the operation of the diode laser module;
the diode laser module emitting a laser beam of a designated wavelength;
a lens optical system employing a homogenizer and causing the laser beam to have a constant size;
the laser beam irradiated through the lens optical system to have a designated width;
a beam transfer unit employing a mask with an adjustable size and guiding the laser beam to a bonding portion of an electric element to the substrate;
upper and lower pressure jig units applying pressure to the substrate, a connecting medium, and the electronic element, which are stacked, while the laser beam incident through the beam transfer unit is upwardly transmitted to the substrate; and
a control unit setting up the intensity of the laser beam, the beam irradiating method and the applied pressure, and providing signals for controlling the laser beam and the upper and lower pressure jig units.

7. The apparatus according to claim 6, wherein the upper pressure jig unit is made of a transparent member, and the upper and lower pressure jig units apply pressure to the substrate, the connecting medium, and the electronic element, which are stacked, while the laser beam incident through the beam transfer unit is downwardly transmitted to the electronic element.

8. The apparatus according to claim 6 or 7, wherein a cooling unit is provided in the upper and lower pressure jig units.

9. The apparatus according to claim 6, wherein a plurality of assemblies, each of which includes the laser driver, the diode laser module, the lens optical system, the beam transfer unit, the upper and lower pressure jig units, and the control unit, are installed so as to simultaneously bond a plurality of electronic elements to the substrate.
